(19) United States
(12) Patent Application Publication
(10) Pub. No.: US 2007/0192429 A1
(43) Pub. Date: Aug. 16, 2007

(54) Digital Composite Machine

(75) Inventors: Daisuke KANUMA, Matsumoto-shi (JP); Satoshi KOTAKA, Azumino-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 11/626,299

(22) Filed: Jan. 23, 2007

(30) Foreign Application Priority Data
Jan. 24, 2006 (JP) 2006-015203

(51) Int. Cl. G06F 15/16

(52) U.S. Cl. 709/208

(57) ABSTRACT

A digital composite machine connectable to a server through a network, includes a scanner, a FAX communicator, a printer, an operation panel, and a controller, operable to accept a first processing request from the operation panel and to control the scanner, the FAX communicator and the printer to execute a first processing based on the first processing request, and operable to accept a second processing request from the server and to control the scanner, the FAX communicator and the printer to execute a second processing based on the second processing request. The controller decides whether or not the first processing is being executed when accepting the second processing request from the server, when the first processing is being executed, the second processing request from the server is rejected, and when the first processing is not being executed, after a lapse of a predetermined time period in which any processing is not executed, the second processing is executed.

### BACKGROUND

1. Technical Field

The present invention relates to a digital composite machine including a FAX transmitting function and being connectable to a network, and more particularly to an art for performing a processing based on a predetermined degree of priority when a plurality of requests competes with each other.

2. Related Art

There is an apparatus which is referred to as a digital composite machine comprising a scanner and a printer (which will be hereinafter referred to as a composite machine). The composite machine has a scanner function for causing a scanner to read an image, a print function for causing a printer to carry out printing and a copy function for causing a printer to print an image read by the scanner. In recent years, there is a composite machine including a FAX transmitting/receiving function (for example, JP-A-2003-30132).

The composite Machine including the FAX transmitting/receiving function can also be connected to a network. In this case, when a request given from an external server connected through the network is to be accepted, there is a possibility that a competition of processing requests for accepting other requests during an execution of a processing for one request might be generated. It is necessary to properly take a countermeasure against the competition.

### SUMMARY

An advantage of some aspects of the invention is to provide an art for properly processing a competition of processing requests which are accepted in a digital composite machine connectable to a network.

According to an aspect of the invention, there is provided a digital composite machine connectable to a server through a network, comprising:

a scanner, operable to read first data;

a FAX communicator, operable to transmit the first data and to receive second data transmitted from a public line;

a printer, operable to print the second data;

an operation panel; and

a controller, operable to accept a first processing request from the operation panel and to control the scanner, the FAX communicator and the printer to execute a first processing based on the first processing request, and operable to accept a second processing request from the server and to control the scanner, the FAX communicator and the printer to execute a second processing based on the second processing request, wherein

the controller decides whether or not the first processing is being executed when accepting the second processing request from the server,

when the first processing is being executed the second processing request from the server is rejected, and

when the first processing is not being executed, after a lapse of a predetermined time period in which any processing is not executed, the second processing is executed.

The present disclosure relates to the subject matter contained in Japanese patent application No. 2006-015203 filed on Jan. 24, 2006, which is expressly incorporated herein by reference in its entirety.

### BRIEF DESCRIPTION OF THE DRAWINGS

The invention will be described with reference to the accompanying drawings, wherein like numbers reference like elements.

FIG. 1 is a diagram showing a whole structure of a FAX transmitting/receiving system according to an embodiment of the invention.

FIG. 2 is a flowchart showing a processing procedure for a controller according to a first mode for priority.

FIG. 3 is a diagram showing an example of a sequence chart according to the first mode for priority.

FIG. 4 is a flowchart showing a processing procedure for the controller according to a second mode for priority.

FIG. 5 is a diagram showing an example of a sequence chart according to the second mode for priority.

FIG. 6 is a flowchart showing a processing procedure for the controller according to a third mode for priority.

FIG. 7 is a diagram showing an example of a Sequence chart according to the third mode for priority.

### DESCRIPTION OF EXEMPLARY EMBODIMENTS

A FAX transmitting/receiving system according to an embodiment of the invention will be described below with reference to the drawings.

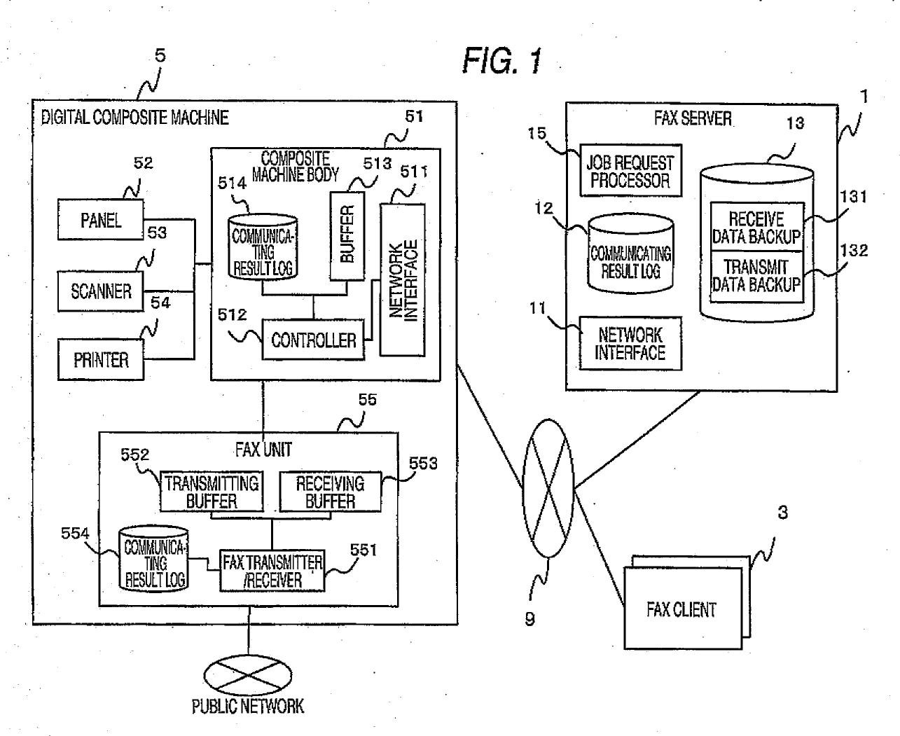

FIG. 1 is a diagram showing a whole structure of the FAX transmitting/receiving system according to the embodiment.

In the system a FAX server 1, a FAX client 3 and a digital composite machine (which will be hereinafter referred to as a composite machine) 5 are connected through a network 9. The numbers of the FAX clients 3 and the composite machines 5 which can be connected to the FAX server 1 can be two or more.

The composite machine 5 includes a composite machine body 51 including an information processor, an operation panel 52 which is an input/output device for accepting an input operation of a user, a scanner 53 for scanning and reading an image, a printer 54 for carrying out printing on a printing medium (for example, a print paper), and a FAX unit 55 for carrying out a FAX transmission/receipt. In other words, the composite machine 5 includes a scanner function, a print function, a copy function obtained by combining the scanner function and the print function, and a FAX transmitting/receiving function.

All of the FAX server 1, the clients 3 and the composite machine body 51 are general-purpose computer systems, for example. Individual components or functions in each server which will be described below, are implemented by an execution of a computer program, for example.

The FAX unit 55 is connected to a public network and comprises a FAX transmitter/receiver 551 for transmitting/receiving FAX, a transmitting buffer 552 for temporarily storing transmit data to be transmitted by the FAX transmitter/receiver 551, a receiving buffer 553 for temporarily storing receive data which are received by the FAX transmitter/receiver 551, and a communicating result log 554 which stores communicating result data indicative of a transmitting/receiving result.

Upon receipt of image data read by the scanner 53 from the composite machine body 51, the FAX unit 55 once stores the same image data in the transmitting buffer 552. The FAX transmitter/receiver 551 acquires the image data stored in the transmitting buffer 552 and transmits the same by FAX. When the transmission is completed, the FAX transmitter/receiver 551 erases the transmitted data which are stored in the transmitting buffer 552.

Upon receipt of the data transmitted by FAX from the public network, the FAX transmitter/receiver 551 once stores the received data in the receiving buffer 553. Then, the receive data stored in the receiving buffer 553 are transmitted to the composite machine body 51 and are printed by the printer 54. The FAX transmitter/receiver 551 deletes the receive data having been printed by the printer 54 from the receiving buffer 553.

The transmitting buffer 552 and the receiving buffer 553 may be integral with each other.

The communicating result log 554 stores a history of a FAX communicating result, for example, a success/failure of the FAX transmission/receipt carried out by the FAX transmitter/receiver 551. For example, the communicating result log 554 stores a communicating result data on a unit of a page and communicating result data on a unit of a job including a plurality of pages.

The FAX unit 55 carries out the FAX transmission/receipt independent of the other structures 51, 52, 53 and 54 in the composite machine 5. In other words, the FAX unit 55 carries out the FAX transmission independently of the composite machine body 51 when accepting the transmit data from the composite machine body 51, and receives FAX data when they are transmitted from the public network. Accordingly, also in the case in which some trouble is made in the network, for example, the FAX unit 55 carries out the FAX transmission/receipt independently thereof.

The composite machine body 51 includes a network interface 511 for carrying out a communication with the FAX server 1 connected through the network 9, a controller 512 for controlling the operation panel 52, the scanner 53, the printer 54 and the FAX unit 55, a buffer 513 for storing FAX data for the FAX transmission/receipt, and a communicating result log 514.

The network interface 511 manages a communicating state with the server 1. For example, the network interface 511 decides whether or not a state in which a normal communication with the server 1 can be carried out is set or a state in which the communication with the server 1 cannot be carried out due to some trouble is set. When a state in which the network 9 can carry out the communication is set, the network interface 511 transmits the communicating result log and the FAX data (transmit data and receive data) to the server 1.

The controller 512 accepts a panel operating job request from the operation panel 52 and then carries out a processing based on the request. Furthermore, the controller 512 also accepts a request for an external starting job from an apparatus connected through the network such as the FAX server 1 and thereafter carries out a processing based on the request.

For example a FAX transmission request and a local copy request correspond to the panel operating job request For example, a FAX transmission request from the FAX server 1 and a scan (network scan) request through the network correspond to the external starting job request.

When accepting the FAX transmitting request, the controller 512 gives an instruction for reading an image to the scanner 53 and acquires image data read by the scanner 53. The image data are stored in the buffer 513. The image data stored in the buffer 513 are transferred to the FAX unit 55 and are transmitted by FAX.

When accepting a FAX receiving request from the FAX unit 55, moreover, the controller 512 acquires receive data which are received from the public network by the FAX unit 55 and stores the same receive data in the buffer 513. The image data stored in the buffer 513 are transferred to the printer 54 and are thus printed.

When the panel operating job request and the external starting job request compete with each other, that is, if one of the requests is accepted when a processing based on the other request is being carried out, the controller 512 preferentially processes one of the requests in accordance with a predetermined degree (order) of priority. The way of determining the degree of priority can be proposed variously.

For example, referring to a first mode for priority, the degree of priority for the panel operating job request is set to be higher than that for the external starting job request. In this case, when the panel operating job request is accepted during an execution of the processing based on the external starting job request, the external starting job request is once stopped and the panel operating job request is processed with priority

Referring to a second mode for priority, the degree of priority for the external starting job request is set to be higher than that for the panel operating job request. In this case, when the external starting job request is accepted during an execution of the processing based on the panel operating job request, the panel operating job request is once stopped and the external starting job request is processed with priority.

Referring to a third mode for priority, a priority order is determined by a type priority degree for each type of a job and an individual priority degree assigned individually to each job irrespective of the panel operating job request or the external starting job request. In this case, the controller 512 compares a priority order determined by a type priority degree and an individual priority degree of a job which is being executed with a priority order determined by a type priority degree and an individual priority degree of a job which is accepted later, and processes the job having a high priority order in preference to the job having a low priority order. In this case, the individual priority degree can be specified every time a user gives a request for each job.

In the composite machine 5 according to the embodiment, the user can select any of the modes for priority. More specifically, the controller 512 carries out a processing in any of the modes for priority which is selected by the user when a plurality of job requests competes with each other.

Moreover, the controller 512 receives a notice of communicating result data obtained by the FAX transmitter/receiver 551 from the FAX unit 55 and stores the same data in the communicating result log 514. Accordingly, the same contents as those in the communicating result log 554 of the FAX unit 55 are stored in the communicating result log 514.

The server 1 includes a network interface 11 for carrying out a communication with the FAX client 3 and the composite machine 5 which are connected through the network 9, a communicating result log 12, a backup data storage 13 and a job request processor 15.

The network interface 11 receives communicating result data and FAX data which are transmitted from the composite machine 5, for example. Then, the network interface 11 stores the communicating result data in the communicating result log 12 and stores the FAX data in the backup data storage 13. Upon receipt of the data from the composite machine 5, the network interface 11 sends a receipt confirmation to the composite machine 5.

A receive data backup 131 and a transmit data backup 132 are stored in the backup data storage 13.

The job request processor 15 gives a request for a job to the composite machine 5 based on an instruction of the FAX client 3. The request for the job is the external starting job request for the composite machine 5.

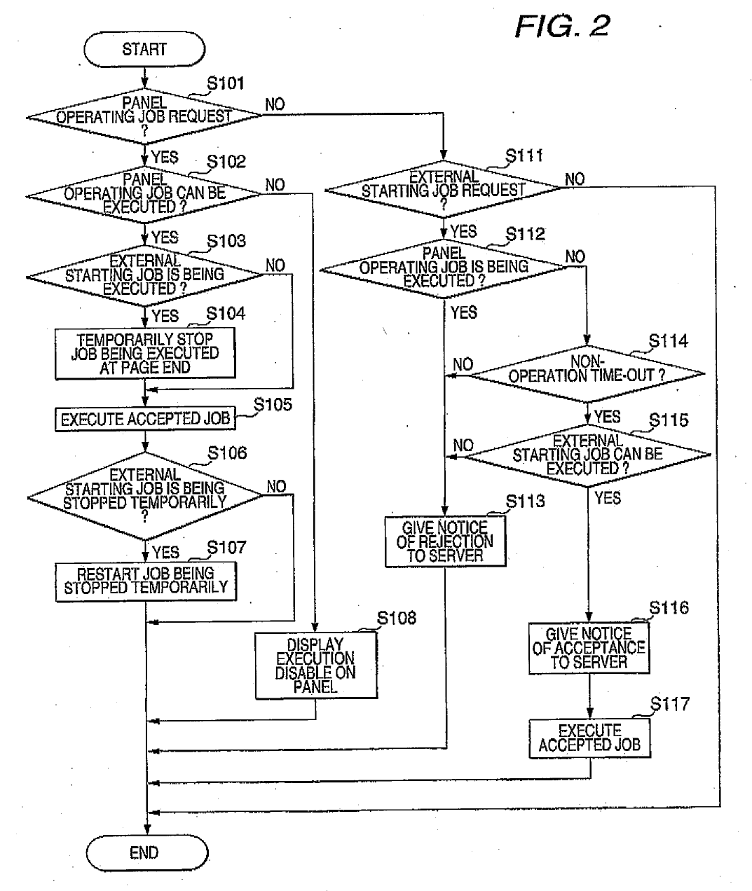

Referring to the FAX transmitting/receiving system having the structure, the processing for each of the modes for priority will be described with reference to FIGS. 2 to 7.

FIG. 2 is a diagram showing a processing procedure for the controller 512 according to the first mode for priority in which the degree of priority for the panel operating job is set to be higher than that for the external starting job.

When the composite machine body 51 first accepts a request for a job, it is decided whether the job is a request for the panel operating job or not (S101).

If the request for the panel operating job is accepted (S101: Yes), the controller 512 confirms a necessary resource for executing the panel operating job and decides whether the panel operating job can be executed or not (S102).

If the panel operating job cannot be executed (S102: No), the purport that a job accepted by the operation panel 52 cannot be executed is displayed and the processing is thus ended (S108).

If the panel operating job can be executed (S102: Yes), the controller 512 decides whether an external starting job is being executed or not (S103). If the external starting job is being executed (S103: Yes), the job which is being executed is temporarily stopped at the time when a predetermined processing unit of the job is ended (S104). Herein, a page unit is set to be the predetermined processing unit and the processing is temporarily stopped at a page end. If the external starting job is not being executed (S103: No), the step S104 is skipped.

Then, the controller 512 executes a processing for the received panel operating job request (S105).

When the processing for the panel operating job is ended, the controller 512 decides whether the external starting job is being temporarily stopped or not (S106). If the external starting job is being temporarily stopped (S106: Yes), the external starting job is restarted (S107).

On the other hand, if the request for the job which is accepted is not the panel operating job (S101: No), it is decided whether a request for the external starting job is accepted or not (S111).

If the request for the external starting job is accepted (S111: Yes), the controller 512 decides whether the panel operating job is being executed or not (S112). If the panel operating job is being executed (S112: Yes), the controller 512 gives a notice of a rejection to the FAX server 1 to be a request source for the external starting job and the processing is thus ended (S113).

If the panel operating job is not being executed at the Step S112 (S112: No), the controller 512 decides whether or not there is brought a state of a non-operation time-out in which at least a predetermined duration for a non-execution of the panel operating job and the external starting job passes (S114). If the non-operation time-out is not brought (S114: No), the processing proceeds to Step S113. In other words, the external starting job is not accepted before the non-operation time-out is brought.

On the other hand, if the non-operation time-out is brought (S114: Yes), the controller 512 confirms a necessary resource for executing the external starting job and decides whether the external starting job can be executed or not (S115). If the external starting job cannot be executed (S115: No), the processing proceeds to the Step S113. If the external starting job can be executed (S115: Yes), a notice that the request is accepted is given to the FAX server 1 to be the request source of the external starting job (S116) and the accepted job is executed (S117).

Consequently, the panel operating job can be executed with priority over the external starting job. Therefore, it is possible to carry out the processing without causing the user giving a job request to the operation panel to wait. Furthermore, the external starting job request is not accepted before the non-operation time-out is brought. Thus, a time required for bringing the non-operation time-out is properly maintained. Consequently, the panel operating job priority is guaranteed.

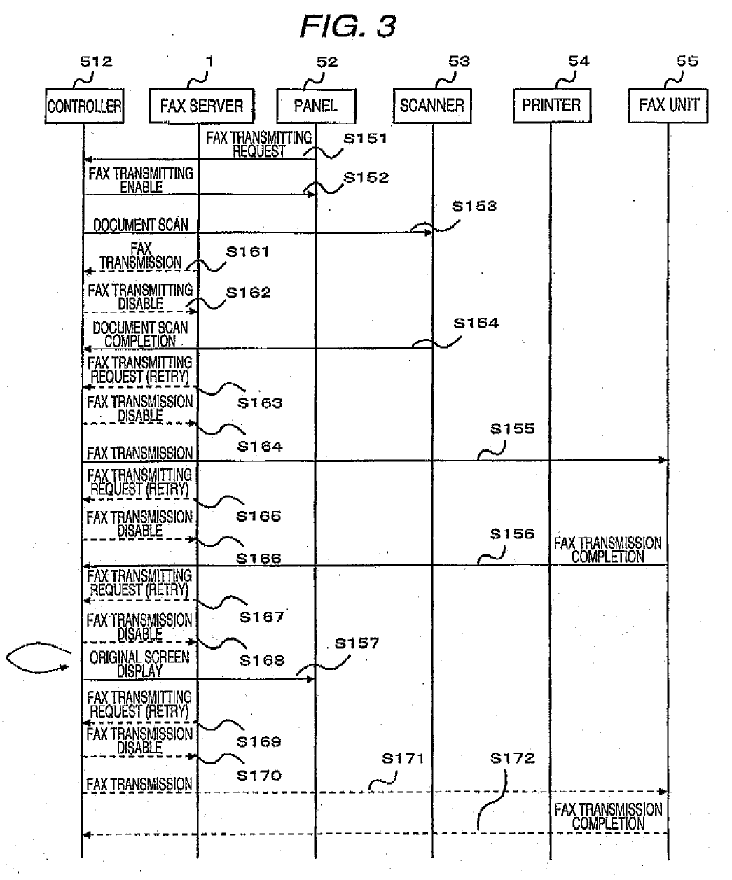

FIG. 3 shows an example of a sequence chart according to the first mode for priority.

First of all, when the user carries out a predetermined operation for the operation panel 52, the operation panel 52 transmits a FAX transmitting request as a panel operating job to the controller 512 (S151).

When the controller 512 accepts the same request, a notice of the purport is given to the operation panel 52 (S152) so that a screen indicating that the processing is being executed is displayed on the operation panel 52. Then, the controller 512 outputs a document scan instruction to the scanner 53 (S153).

At this time, when a FAX transmitting request is given as the external starting job from the FAX server 1, the request is rejected (S161, S162). Then, the FAX server 1 retries the FAX transmitting request at a predetermined time interval. However, the same request is rejected until the processing of the FAX transmitting request through the panel operation at the Step S151 is ended (S163 to S166).

When the scanner 53 completes the document scan, a notice of the scanned image data is given to the controller 512 (S154). The controller 512 transmits the image data to the FAX unit 55 and gives an instruction for a FAX transmission (S155).

When the FAX transmission is completely carried out by the FAX unit 55, a notice of the purport is given to the controller 512 so that the processing of the FAX transmitting request through the panel operation is ended (S156).

When the FAX transmitting request is given from the FAX server 1 before the non-operation time-out is brought immediately after the processing is ended (S167), the same request is also rejected (S168).

When the non-operation time-out is brought, the controller 512 causes the operation panel 52 to display an original screen capable of accepting the request for the panel operating job (S157).

When the FAX transmitting request is then given from the FAX server 1 (S169), the request is accepted (S170) and is transmitted from the FAX unit 55 (S171, 172).

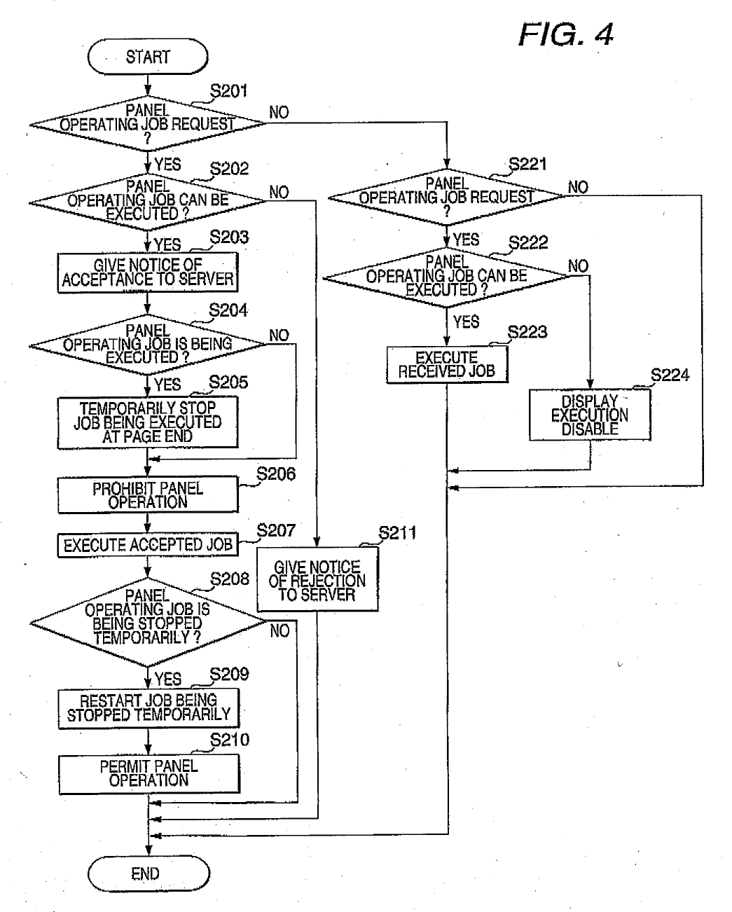

FIG. 4 is a diagram showing a processing procedure for the controller 512 according to the second mode for priority in which the degree of priority for the external starting job is set to be higher than that for the panel operating job.

When the composite machine body 51 first accepts a request for a job, it is decided whether a request for the external starting job is accepted or not (S201).

If the request for the external starting job is accepted (S201: Yes), the controller 512 confirms a necessary resource for executing the external starting job and decides whether the external starting job can be executed or not (S202).

If the external starting job cannot be executed (S202: No), a notice of the purport that the accepted job cannot be executed is given to the FAX server 1 to be the request source of the external starting job and the processing is thus ended (S211).

If the external starting job can be executed (S202: Yes), the controller 512 gives the FAX server 1 a notice that the job is accepted (S203). Furthermore, the controller 512 decides whether the panel operating job is being executed or not (S204). If the panel operating job is being executed (S204: Yes), the job which is being executed is temporarily stopped when a predetermined processing unit of the job is ended (S205). Herein, a page unit is set to be the predetermined processing unit and the processing is temporarily stopped at a page end. If the panel operating job is not being executed (S204: No), the step S205 is skipped.

Then, the controller 512 gives the operation panel 52 a notice of a panel operation prohibition (S206) and executes the received external starting job (S207).

When the external starting job is ended, the controller 512 decides whether the panel operating job is being temporarily stopped or not (S208). If the panel operating job is being temporarily stopped (S208: Yes), the panel operating job is restarted and the panel operation prohibited at the Step S206 is permitted (S209, S210).

On the other hand, if the request for the external starting job is not accepted (S201: No), the controller 512 decides whether a request for the panel operating job is accepted or not (S221).

If the request for the panel operating job is accepted (S221: Yes) the controller 512 confirms a necessary resource for executing the panel operating job and decides whether the panel operating job can be executed or not (S222). If the panel operating job cannot be executed (S222: No), the operation panel 52 is caused to display a screen indicating that the accepted job cannot be executed and the processing is thus ended (S224).

If the panel operating job can be executed (S222: Yes), the accepted job is executed (S223).

Consequently, the external starting job can be executed with priority over the panel operating job. Therefore, it is possible to carry out the processing without waiting due to the pal operating job.

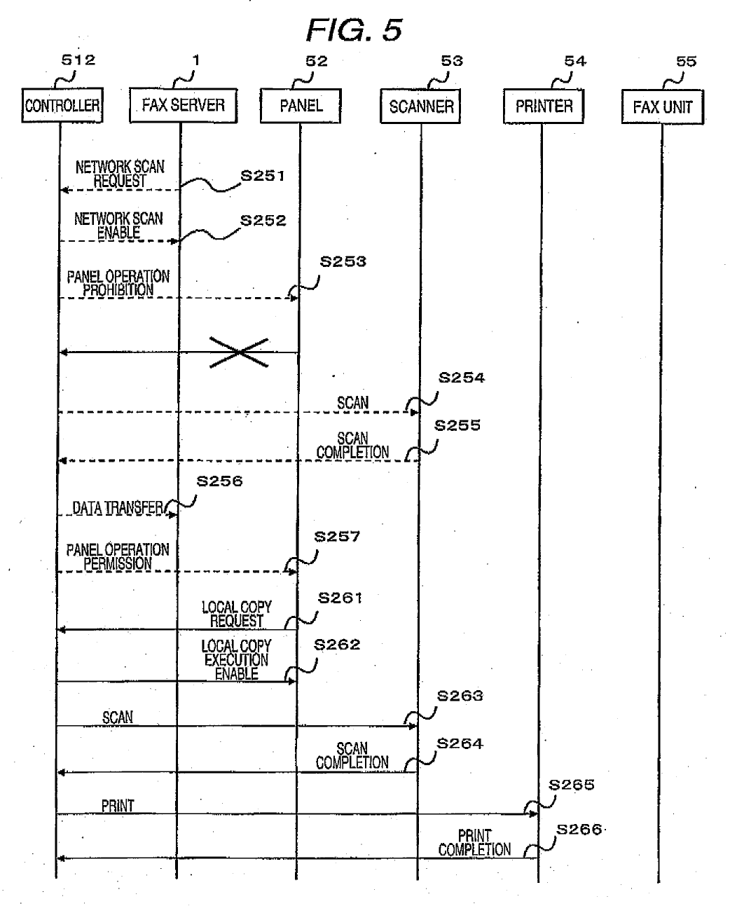

FIG. 5 shows an example of a sequence chart according to the second mode for priority.

First of all, the controller 512 accepts a network scan request as the external starting job sent from the FAX server 1 (S251). Then, the controller 512 gives the FAX server 1 a notice that the accepted request can be executed (S252).

Thereafter, the controller 512 prohibits the panel operation (S253) Consequently the controller 512 does not accept the operation sent from the operation panel 52.

The controller 512 outputs a document scan instruction to the scanner 53 (S254). When the scanner 53 completes the document scan, a notice of scanned image data is given to the controller 512 (S255). Subsequently, the controller 512 transfers the image data to the FAX server 1 (S256).

When the data transfer to the FAX server 1 is completed, the processing for the network scan request accepted at the Step S251 is ended so that the controller 512 releases the panel operation prohibition and permits the panel operation (S257).

Since the panel operation is permitted, the controller 512 can accept the panel operating job. In other words, when accepting a local copy request from the operation panel 52 (S261), the controller 512 gives the operation panel 52 a notice that the same request can be executed (S262).

The controller 512 causes the scanner 53 to scan a document in accordance with the accepted request (S263, S264), and causes the printer 54 to print image data obtained by the scan (S265, S266).

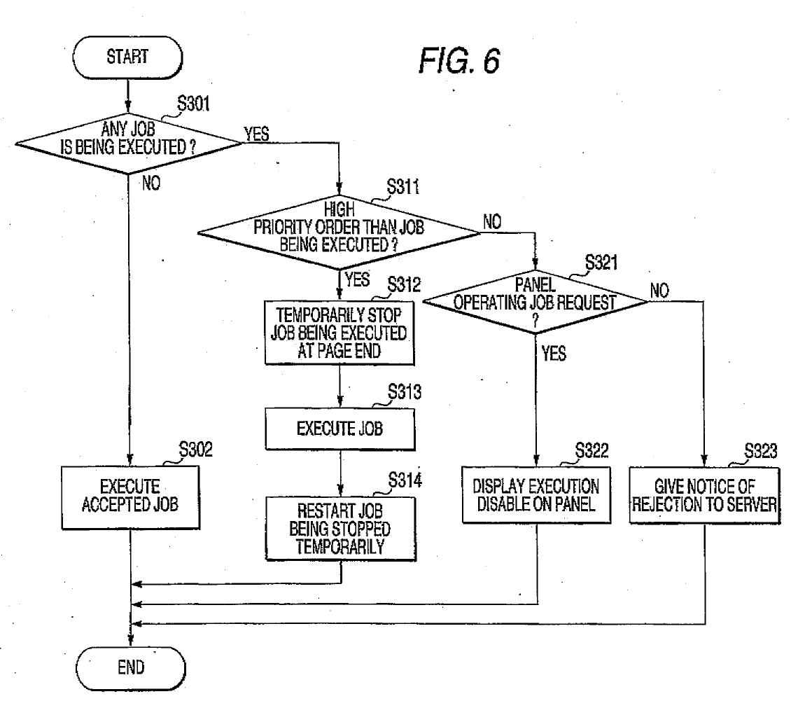

FIG. 6 is a diagram showing a processing procedure for the controller 512 according to the third mode for priority in which a priority order is determined based on a type priority degree for each type of a job and an individual priority degree assigned individually to each job irrespective of the panel operating job request or the external starting job request.

The type priority degree is predetermined for a type of each processing request such as a FAX transmitting request, a local copy or a network scan. A user specifies the individual priority degree for each job when giving a request for a job. By a combination of the type priority degree and the individual priority degree, the priority order of each job is determined. For example, if the type priority degree and the individual priority degree are set into two stages of “High” and “Low” respectively, a job of “High” has the highest priority and A job of “Low” has the lowest priority order.

First of all, when accepting a request for a job, the composite machine body 51 decides whether any job is being executed or not (S301).

When any job is not being executed (S301: No), the accepted job is executed and the processing is thus ended (S302).

When any job is being executed (S301: Yes), the controller 512 decides priority orders for the accepted job and the job which is being executed and decides whether or not the accepted job has a higher priority order than the job which is being executed (S311).

When the priority order of the accepted job is higher than that of the job which is being executed (S311: Yes), the controller 512 temporarily stops the job which is being executed when a predetermined processing unit of the job is ended (S312). Herein, the predetermined processing unit is set to be a page unit and the temporary stop is carried out at a page end.

Then, the accepted job is executed. When the same job is ended, the job which is being temporarily stopped is restarted (S313, S314).

When the priority order of the accepted job is not higher than that of the job which is being executed at the Step S311 (S311: No), the controller 512 decides whether the accepted job is a panel operating job or not.

If the accepted job is the panel operating job (S321: Yes), a purport that the accepted job cannot be executed is displayed on the operation panel 52 (S322). If the accepted job is not the panel operating job (S321: No), the controller 512 gives the FAX server 1 a notice of a rejection for the job and ends the processing (S323).

Consequently, it is possible to execute the job in accordance with the priority order determined by the combination of the type priority degree and the individual priority degree irrespective of the external starting job or the panel operating job.

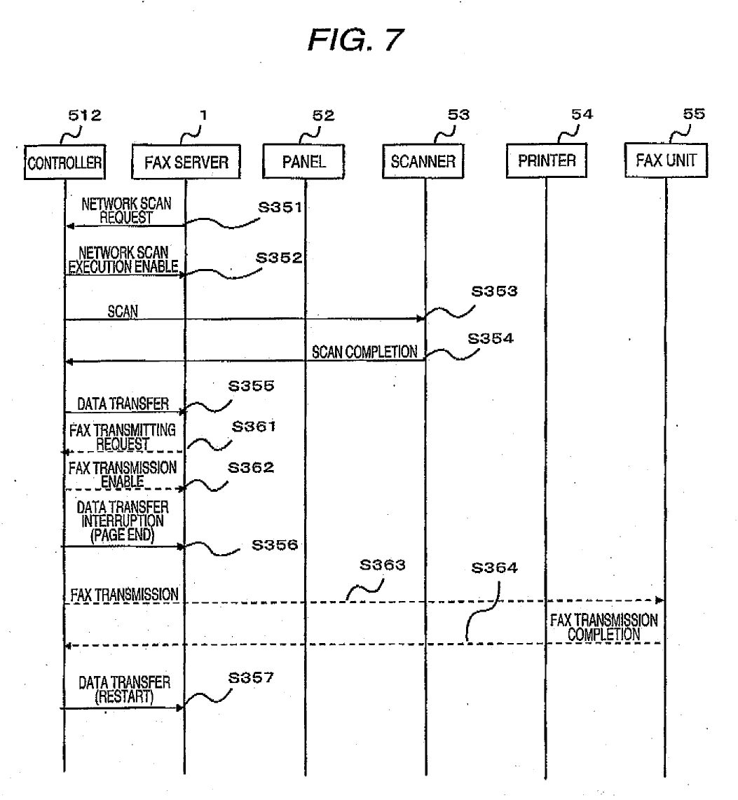

FIG. 7 shows an example of a sequence chart according to the third mode for priority.

First of all, the controller 512 accepts a network scan request as the external starting job from the FAX server 1 (S351). Then, the controller 512 gives the FAX server 1 a notice that the accepted request can be executed (S352).

The controller 512 outputs a document scan instruction to the scanner 53 (S353). When the scanner 53 completes the documents scan, a notice of scanned image data is given to the controller 512 (S354). Thereafter, the controller 512 transfers the image data to the FAX server 1 (S355).

When a FAX transmitting request is given from the FAX server 1 during a data transfer at the Step S355, the controller 512 accepts the same request (S361). If a priority order of the FAX transmitting request is higher than that of the network scan, the controller 512 gives the FAX server 1 a notice that the FAX transmitting request is accepted (S362).

Then, the controller 512 interrupts the data transfer of the network scan at the page end (S356) and the processing for the FAX transmitting request at the Step S361 is executed with priority. More specifically, the controller 512 gives an instruction for a FAX transmission to the FAX unit 55 and causes the FAX unit 55 to carry out the FAX transmission (S363, S364).

When the processing for the FAX transmitting request at the Step S361 is completed, the interrupted data transfer of the network scan is restarted (S357).

The embodiments according to the invention are only illustrative for explaining the invention and the range of the invention is not restricted to the embodiments. The skilled in the art can execute the invention in various modes without departing from the scope of the invention.

For example, while the description has been given to the example of FIG. 3 in which the FAX transmitting request is accepted as the external starting job, the network scan may be accepted in place of the FAX transmitting request.

While the description has been given to the examples of FIGS. 5 and 7 in which the network scan is accepted as the external starting job, the FAX transmitting request may be accepted in place of the network scan.

What is claimed is:

1. A digital composite machine connectable to a server through a network, comprising:
a scanner, operable to read first data;
a FAX communicator, operable to transmit the first data and to receive second data transmitted from a public line;
a printer, operable to print the second data;
an operation panel; and
a controller, operable to accept a first processing request from the operation panel and to control the scanner, the FAX communicator and the printer to execute a first processing based on the first processing request, and operable to accept a second processing request from the server and to control the scanner, the FAX communicator and the printer to execute a second processing based on the second processing request, wherein
the controller decides whether or not the first processing is being executed when accepting the second processing request from the server,
when the first processing is being executed, the second processing request from the server is rejected, and
when the first processing is not being executed, after a lapse of a predetermined time period in which any processing is not executed, the second processing is executed.

2. The digital composite machine according to claim 1, wherein
the controller decides whether or not the second processing is being executed when accepting the first processing request from the operation panel, and
when the second processing is being executed, after a predetermined unit of the second processing has been executed, the second processing is interrupted and the first processing is executed.

3. The digital composite machine according to claim 1, wherein the second processing request from the server is a FAX transmitting request.

4. The digital composite machine according to claim 3, wherein
the first processing request from the operation panel is a FAX transmitting request or a local copy request.

5. A method of processing a FAX transmitting request in a digital composite machine which is connectable to a server through a network and comprises: a scanner, operable to read first data; a FAX communicator, operable to transmit the first data and to receive second data transmitted from a public line; a printer, operable to print the second data; and an operation panel, the method comprising:
deciding whether or not a processing based on a processing request from the operation panel is being executed when accepting a FAX transmitting request from the server;
when the processing based on the processing request from the operation panel is being executed, rejecting the FAX transmitting request from the server; and
when the processing based on the processing request from the operation panel is not being executed, after a lapse of a predetermined time period in which any processing is not executed, executing a processing based on the FAX transmitting request from the server.

6. A computer-readable recording medium in which a computer program causing the digital composite machine to execute the method according to claim 5 is recorded.
